(19) United States
(12) Patent Application Publication
(10) Pub. No.: US 2025/0255285 A1
(43) Pub. Date: Aug. 14, 2025

(54) FISHING LINE INFORMATION LEARNING SYSTEM

(71) Applicant: Shimano Inc., Sakai (JP)

(72) Inventors: Hirotaka HONDA, Sakai (JP); Youhei TOAKE, Sakai (JP); Takuya YASHIKI, Sakai (JP); Keigo KITAJIMA, Sakai (JP); Kenji YOSHIDA, Sakai (JP)

(21) Appl. No.: 19/013,667

(22) Filed: Jan. 8, 2025

(30) Foreign Application Priority Data
Feb. 9, 2024 (JP) 2024-018925

(51) Int. Cl. A01K 91/20; A01K 89/00; G06T 7/62

(52) U.S. Cl. CPC A01K 91/20; A01K 89/00; G06T 7/62

(57) ABSTRACT

A fishing line information learning system includes a fishing reel having a first communication unit and a spool, and an electronic device having a camera to photograph the spool, a second communication unit to communicate with the first communication unit, and a first memory to store first information acquired by the camera. The fishing reel or the electronic device has a second memory to store a calculation formula to calculate a line winding amount of the fishing line from a first time point when the winding of the fishing line is started to a second time point when the winding of the fishing line is ended, and a controller to estimate a final line winding diameter at the second time point based on the first information at the second time point, and calculate the line winding amount based on the final line winding diameter and the calculation formula.

### CROSS-REFERENCE TO RELATED APPLICATIONS

This application claims priority to Japanese Patent Application No. 2024-018925, filed on Feb. 9, 2024. The entire disclosure of Japanese Patent Application No. 2024-018925 are hereby incorporated by reference.

### BACKGROUND

### Technical Field

The present disclosure relates to a fishing line information learning system.

### Background Information

Some conventional fishing reels, such as electric reels, have a learning mode (refer to Japanese Laid Open Patent Application No. 2002-65127). In the learning mode, the relationship between the length of the fishing line wound around the spool and the rotational position of the spool can be learned and set. The electric reel thereby estimates the location or the flight distance of the tackle. In this type of electric reel, an angler operates a plurality of operation keys to input and set learning mode settings, for example, information such as the type and thickness (line size) of the fishing line, the length of the fishing line that is wound, and the like.

### SUMMARY

In a conventional electric reel, the setting process in the learning mode is carried out by operating a plurality of operation keys. It has been determined that, here, in a conventional electric reel, the space for arranging the operation keys is limited such that only a small number of operation keys can be made available. This configuration increases the number of operations to be performed with the operation keys during the setting process in the learning mode. That is, it is problematic that the operations for the setting process is cumbersome.

In addition, in a conventional electric reel, in the learning mode, the relationship between the fishing line length and the rotational position of the spool is set when the fishing line is wound around the spool. However, when the setting process is incorrectly performed in the learning mode, for example, when the setting information is erroneously input or the power supply is interrupted during winding, it is necessary to re-wind the fishing line.

An object of the present disclosure is to provide a fishing line information learning system in which it is easy to set fishing line information used in a learning mode.

In one aspect of the present disclosure, a fishing line information learning system comprises a fishing reel and an electronic device. The fishing reel has a first communication unit and a spool including a pair of flange portions and a bobbin trunk around which a fishing line is wound between the pair of flange portions. The electronic device has a camera configured to be capable of photographing the spool, a second communication unit that can communicate with the first communication unit, and a first memory that stores first information acquired by the camera.

The fishing reel and/or the electronic device has a second memory and a controller. The second memory stores a calculation formula used for calculating a line winding amount of the fishing line in a range from a first time point when the winding of the fishing line is started to a second time point when the winding of the fishing line is ended. The controller estimates a final line winding diameter at the second time point on the basis of the first information at the second time point, and calculates the line winding amount on the basis of the final line winding diameter at the second time point and the calculation formula.

In the fishing line information learning system according to the first aspect, the camera of the electronic device photographs the spool of the fishing reel. At this time, the first memory of the electronic device acquires the first information acquired by the camera. The controller of the fishing reel and/or the electronic device estimates the final line winding diameter at the second time point on the basis of the first information at the second time point. Here, the second time point is the point in time at which the winding of the fishing line ends. The controller calculates the line winding amount on the basis of the final line winding diameter at the second time point and the calculation formula in the second memory.

In this manner, according to this fishing line information learning system, the angler can acquire the first information at the second time point from the camera to easily set the fishing line information used in the learning mode, without having to carry out cumbersome operations or tasks.

A second aspect of the present disclosure is the fishing line information learning system according to the first aspect, configured as follows. The first memory and/or the second memory stores the outer diameter of the bobbin trunk, or initial line winding diameter information corresponding to the initial line winding diameter at the first time point. The controller calculates the line winding amount on the basis of the final line winding diameter at the second time point, the initial line winding diameter information, the actual line winding amount in the range described above, and the calculation formula.

In the fishing line information learning system according to the second aspect, by preparing the final line winding diameter at the second time point, the initial line winding diameter information, the actual line winding amount in the range described above, and the calculation formula, the fishing line information used in the learning mode can be easily set.

A third aspect of the present disclosure is the fishing line information learning system according to the first aspect, configured as follows. The first memory and/or the second memory stores the outer diameter of the bobbin trunk, or initial line winding diameter information corresponding to the initial line winding diameter at the first time point, and second information relating to the fishing line. The controller calculates the line winding amount on the basis of the final line winding diameter at the second time point, the initial line winding diameter information, the second information, and the calculation formula.

In the fishing line information learning system according to the third aspect, by preparing the final line winding diameter at the second time point, the initial line winding diameter information, the second information, and the calculation formula, the fishing line information used in the learning mode can be easily set.

A fourth aspect of the present disclosure is the fishing line information learning system according to the first aspect, configured as follows. The fishing reel has a measuring unit that measures the number of rotations of the spool. The first memory and/or the second memory stores the outer diameter of the bobbin trunk, or initial line winding diameter information corresponding to the initial line winding diameter at the first time point.

The controller recognizes the final line winding diameter at the second time point as a first final line winding diameter. The controller recognizes, as a measured number of rotations, the number of rotations of the spool measured by the measuring unit between the second time point and a third time point at which a prescribed length of the fishing line has been pulled out. The controller estimates a second final line winding diameter at the third time point on the basis of the first information at the third time point. The controller calculates the line winding amount on the basis of the first final line winding diameter, the initial line winding diameter information, the measured number of rotations, the second final line winding diameter, and the calculation formula.

In the fishing line information learning system according to the fourth aspect, a prescribed length of fishing line is pulled out between the second time point and the third time point. At this time, the measured number of rotations is measured by the measuring unit. The camera of the electronic device photographs the spool of the fishing reel at the third time point. At this time, the first information at the third time point is acquired. The second final line winding diameter at the third time point is estimated on the basis of the first information at the third time point.

By preparing the first final line winding diameter at the second time point, the initial line winding diameter information, the measured number of rotations, the second final line winding diameter at the third time point, and the calculation formula, the fishing line information used in the learning mode can be easily set.

A fifth aspect of the present disclosure is the fishing line information learning system according to any one of the first to the fourth aspects, configured as follows. The flange portion and/or the bobbin trunk includes an identification information display portion that includes third information relating to the spool. The identification information display portion includes at least any one of a one-dimensional barcode, a two-dimensional barcode, and character information. When the identification information display portion is photographed by the camera, the controller stores the third information relating to the spool in the first memory and/or the second memory.

In the fishing line information learning system according to the fifth aspect, the identification information display portion can be photographed by the camera to easily acquire the third information relating to the spool.

A sixth aspect of the present disclosure is the fishing line information learning system according to the fifth aspect, configured as follows. The electronic device has a display unit for displaying information in the first memory. The display unit displays the third information relating to the spool.

In the fishing line information learning system according to the sixth aspect, the angler can look at the third information on the display unit to ascertain information on the spool.

A seventh aspect of the present disclosure is the fishing line information learning system according to the fifth aspect, configured as follows. The controller generates table data indicating the relationship between the calculation formula and the third information relating to the spool. The controller stores the table data in the first memory and/or the second memory.

In the fishing line information learning system according to the seventh aspect, the third information relating to the spool is linked with the calculation formula, making it possible to store the calculation formula corresponding to each spool.

An eighth aspect of the present disclosure is the fishing line information learning system according to the fifth aspect, configured as follows. The flange portion and/or the bobbin trunk has a recess. The identification information display portion is provided in the recess.

In the fishing line information learning system according to the eighth aspect, the identification information display portion is provided in the recess, making it possible to prevent peeling of the identification information display portion.

According to the present disclosure, it is possible to easily set fishing line information used in a learning mode in a fishing line information learning system.

### BRIEF DESCRIPTION OF THE DRAWINGS

FIG. 1 is a conceptual diagram of a fishing line information learning system according to the first to the third embodiments of the present disclosure.

FIG. 2 is a functional block diagram of a smartphone and an electric reel in the fishing line information learning system.

FIG. 3 is an external perspective view of the electric reel.

FIG. 4A is a front view of a spool.

FIG. 4B is a front view of the spool.

FIG. 5 is a flowchart showing a way of setting fishing line information used in a learning mode in the first embodiment.

FIG. 6 is a graph showing the relationship between a line winding amount and a number of rotations of the spool in the first embodiment.

FIG. 7 is a flowchart showing a way of setting fishing line information used in a learning mode in the second embodiment.

FIG. 8 is a flowchart showing a way of setting fishing line information used in a learning mode in the third embodiment.

FIG. 9 is a graph showing the relationship between a line winding amount and a number of rotations of the spool in the third embodiment.

### DETAILED DESCRIPTION

### First Embodiment

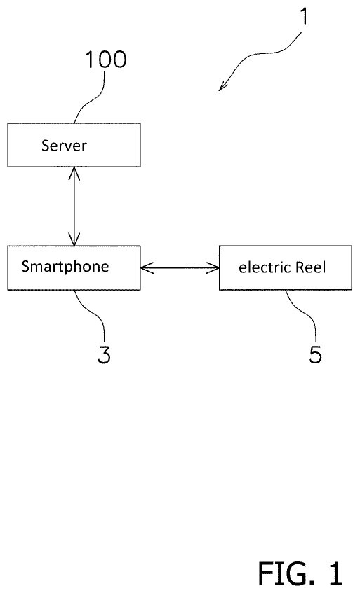

As shown in FIG. 1, a fishing line information learning system 1 comprises a smartphone 3 and an electric reel 5. In the fishing line information learning system 1, the smartphone 3 and the electric reel 5 are configured to be capable of communicating with each other. The smartphone 3 is configured to be capable of communicating with a server 100 via the Internet. The server 100 communicates with the smartphone 3 and stores various information used by the fishing line information learning system 1.

In the present embodiment, the electric reel 5 is one example of a fishing reel and the smartphone 3 is one example of an electronic device. Hereinbelow, the term “information” can be used. The term “information” can be interpreted to mean “data.”

### Smartphone

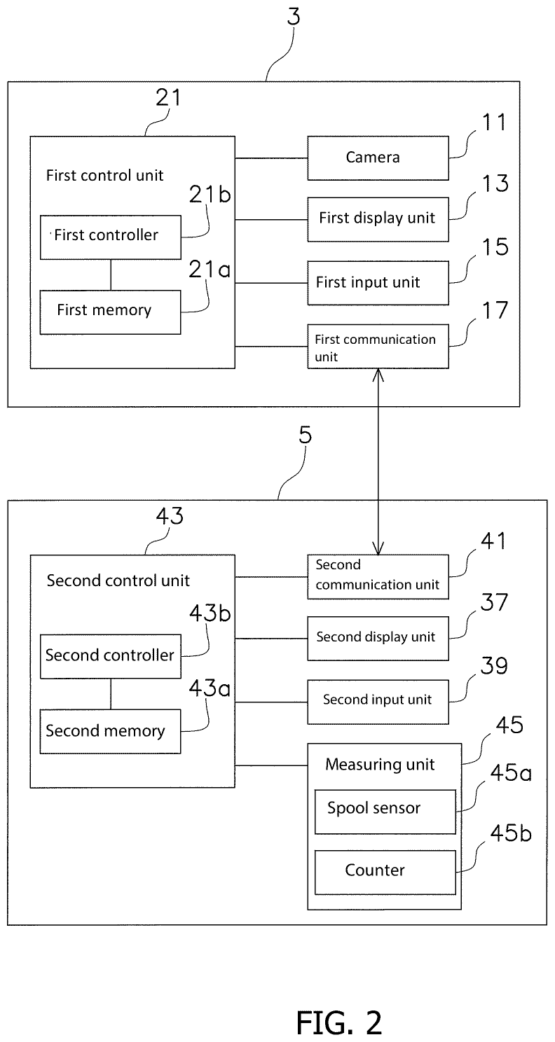

As shown in FIG. 2, the smartphone 3 has a camera 11, a first display unit 13 (one example of a display unit), and a first input unit 15. The smartphone 3 has a first communication unit 17 and a first control unit 21. The camera 11 is configured to be capable of photographing a spool 35, etc., of the electric reel 5, described further below.

The first control unit 21 includes a first memory 21a and a first controller 21b. The first memory 21a is nonvolatile memory. The first memory 21a includes ROM (Read Only Memory) and RAM (Random Access Memory). The first memory 21a stores various programs for operating the smartphone 3. The first memory 21a stores various data used in the various programs.

The first memory 21a stores various information used in the learning mode. The first memory 21a stores fishing line information (one example of second information) relating to the fishing line. The fishing line information includes the line size of the fishing line, the diameter of the fishing line, the type (material) of the fishing line, and the like.

The first controller 21b includes a CPU (Central Processing Unit). The first controller 21b reads various programs from the first memory 21a and executes the various programs. For example, the first controller 21b analyzes image data captured by the camera to estimate the line winding diameter of the spool and stores the estimated value in the first memory 21a as line winding diameter information.

The first controller 21b controls the first display unit 13. For example, with respect to the first display unit 13, the first controller 21b controls the first display unit 13 on the basis of a display program stored in the first memory 21a. As a result, various information in the first memory 21a is displayed on the first display unit 13.

The first controller 21b recognizes input of the first input unit 15. For example, when the first input unit 15 is operated, the first controller 21b acquires an operation signal from the first input unit 15 and executes a command corresponding to the operation signal. Alternatively, the first controller 21b stores, in the first memory 21a, input information that is input from the first input unit 15 or input information that is selected by the first input unit 15.

The first controller 21b controls the first communication unit 17. For example, the first controller 21b issues, to the first communication unit 17, a command relating to sending and receiving information. Specifically, the first controller 21b issues, to the first communication unit 17, a command to read various information from the first memory 21a and to send the various information to the second communication unit. Alternatively, the first controller 21b issues, to the first communication unit 17, a command to receive information sent from the second communication unit.

### Electric Reel

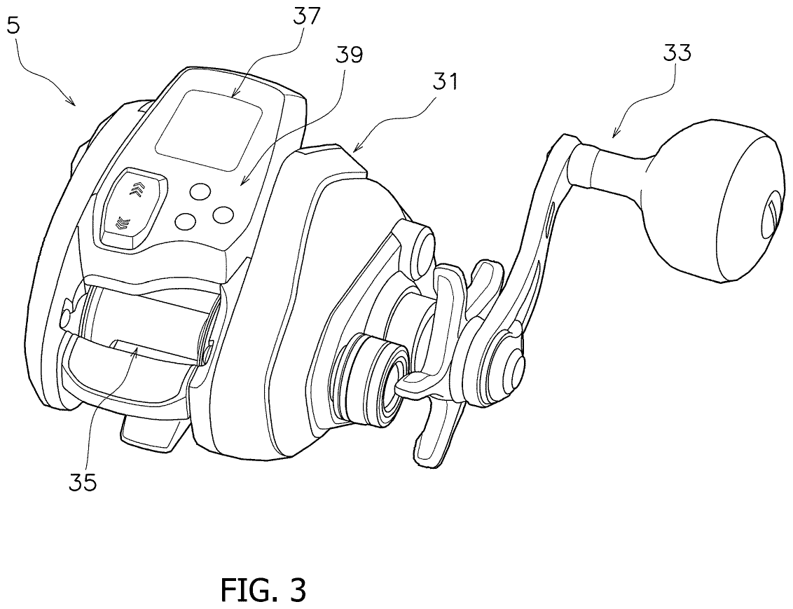

As shown in FIG. 3, the electric reel 5 includes a reel body 31, a handle 33, the spool 35, a second display unit 37, and a second input unit 39. As shown in FIG. 2, the electric reel 5 includes a second communication unit 41 and a second control unit 43. The electric reel 5 further includes a measuring unit 45.

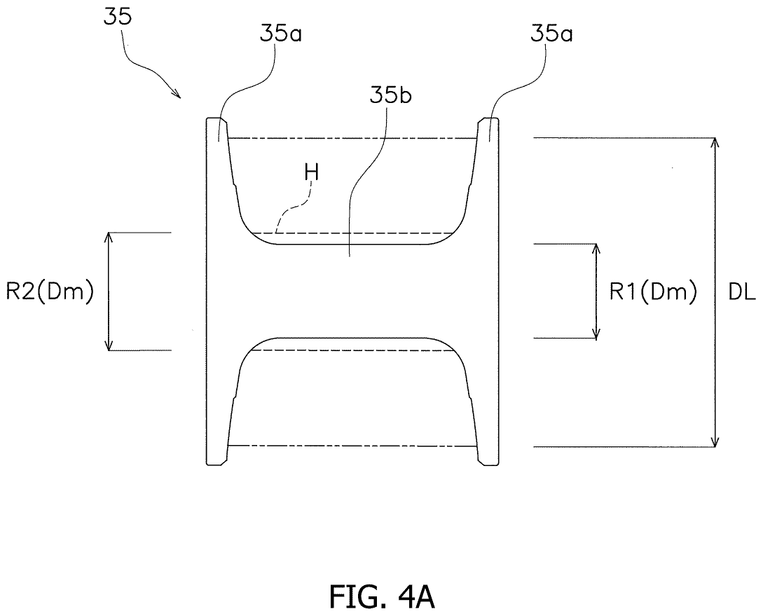

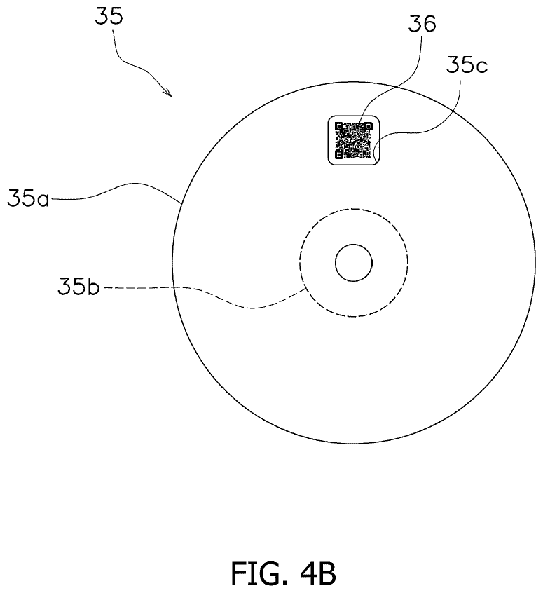

As shown in FIG. 3, the handle 33 is supported by the reel body 31 such that rotational operation is possible. The spool 35 is supported by the reel body 31 so as to be rotatable. As shown in FIG. 4A, the spool 35 includes a pair of flange portions (flanges) 35a and a bobbin trunk 35b. The pair of flange portions 35a are arranged facing each other. The bobbin trunk 35b is provided between the pair of flange portions 35a. For example, a fishing line is wound around the bobbin trunk 35b by rotating the handle 33. Alternatively, the fishing line can be wound around the bobbin trunk 35b by rotating a motor (not-shown) arranged inside the reel body 31.

As shown in FIG. 4B, an identification information display portion 36 is provided on one of the pair of flange portions 35a. Specifically, the identification information display portion 36 is disposed on the outer surface of the flange portion 35a. Specifically, a recess 35c is provided on the outer surface of the flange portion 35a, and the identification information display portion 36 is disposed in the recess 35c.

In the present embodiment, an example is shown in which the identification information display portion 36 is provided on the outer surface of the flange portion 35a, but the identification information display portion 36 can be provided on an axially outer side surface of the bobbin trunk 35b. In this case, the recess 35c is disposed on the axially outer side surface of the bobbin trunk 35b, and the identification information display portion 36 is disposed in this recess 35c.

The identification information display portion 36 includes spool information (one example of third information) relating to the spool 35. Specifically, the identification information display portion 36 includes at least any one of a one-dimensional barcode, a two-dimensional barcode, and character information. At least one of the one-dimensional barcode, the two-dimensional barcode, and the character information includes spool information or an access means for obtaining the spool information.

The spool information includes information unique to the spool, such as the name of the spool 35, the type of the spool 35, the flange diameter of the spool 35, the line winding width of the spool 35, and the outer diameter R1 of the bobbin trunk 35b. The identification information display portion 36 can be photographed by the camera 11 of the smartphone 3. In this case, the spool information is stored in the first memory 21a.

As shown in FIG. 3, the second display unit 37 is provided in the reel body 31. The second display unit 37 displays various information relating to the electric reel 5. The various information relating to the electric reel 5 includes information on the learning mode. As shown in FIG. 2, the second display unit 37 is controlled by the second control unit 43.

As shown in FIG. 3, the second input unit 39 is arranged around the second display unit 37. The second input unit 39 is used for switching and displaying various information on the second display unit 37, and providing various information to the electric reel 5.

The second input unit 39 can be an input unit like physical buttons, or the like. The second input unit 39 can be an input unit like a touch panel, or the like. When the second input unit 39 is realized by a touch panel, the second input unit 39 is integrated into the second display unit 37. As shown in FIG. 2, input of the second input unit 39 is controlled by the second control unit 43.

As shown in FIG. 2, the second communication unit 41 is configured so as to be capable of communicating with the first communication unit 17. The second communication unit 41 has wireless communication capabilities, such as using BLUETOOTH (registered trademark). The second communication unit 41 can be connected to the first communication unit 17 wirelessly, or connected to the first communication unit 17 by wire. The second communication unit 41 is controlled by the second control unit 43.

The second communication unit 41 sends various information to the first communication unit 17 by operation of the first input unit 15 and/or the second input unit 39. The second communication unit 41 can also automatically send various information to the first communication unit 17 without operation of the first input unit 15 or the second input unit 39.

As shown in FIG. 2, the second control unit 43 has a second memory 43a and a second controller 43b. The second memory 43a is nonvolatile memory. The second memory 43a includes ROM (Read Only Memory) and RAM (Random Access Memory). The second memory 43a stores various programs for operating the electric reel 5. The second memory 43a stores various data used in the various programs.

For example, the second memory 43a stores line winding diameter information acquired from the smartphone 3, various information relating to the electric reel 5, and various information used in the learning mode. The second memory 43a stores fishing line information relating to the fishing line. The fishing line information in the second memory 43a can be sent and received between the smartphone 3 and the electric reel 5 via the first communication unit 17 of the smartphone 3 and the second communication unit 41 of the electric reel 5.

The second memory 43a stores a calculation formula for calculating various information used in the learning mode. For example, the calculation formula is used for calculating the line winding amount of the fishing line in a range from a first time point when the winding of the fishing line is started to a second time point when the winding of the fishing line is ended. The second memory 43a stores coefficients and variable values used in the calculation formula.

As shown in FIG. 2, the second controller 43b includes a CPU (Central Processing Unit). The second controller 43b reads various programs from the second memory 43a and executes the various programs. For example, the second controller 43b controls the electric reel 5. The second controller 43b reads, from the second memory 43a, various electric reel programs for operating the electric reel 5 to control the electric reel 5. The second controller 43b executes display control of the second display unit 37 and motor drive control for controlling the rotation of the spool 35.

The second controller 43b controls the second display unit 37. For example, with respect to the second display unit 37, the second controller 43b controls the second display unit 37 on the basis of a display program stored in the second memory 43a. As a result, various information in the second memory 43a is displayed on the second display unit 37.

The second controller 43b recognizes input of the second input unit 39. For example, when the second input unit 39 is operated, the second controller 43b acquires an operation signal from the second input unit 39 and executes a command corresponding to the operation signal. The second controller 43b stores, in the first memory 21a, input information that is input from the second input unit 39 or input information that is selected by the second input unit 39.

The second controller 43b controls the second communication unit 41. For example, the second controller 43b issues, to the second communication unit 41, a command relating to sending and receiving information. Specifically, the second controller 43b issues, to the second communication unit 41, a command to read various information from the second memory 43a and to send the various information to the first communication unit 17. The second controller 43b issues, to the second communication unit 41, a command to receive information sent from the first communication unit 17.

As shown in FIG. 2, the measuring unit 45 measures the number of rotations of the spool 35. For example, the measuring unit 45 includes a spool sensor 45a and a counter 45b. The spool sensor 45a is provided on the reel body 31. The spool sensor 45a is disposed facing a magnet provided on the spool 35. When the spool 35 rotates, the spool sensor 45a detects the rotation direction of the spool 35. Data indicating the rotation direction of the spool 35 are stored in the second memory 43a and recognized by the second controller 43b.

The counter 45b shown in FIG. 2 is provided on the reel body 31. The counter 45b detects a signal output from the spool sensor 45a. With this detection, the counter 45b measures the number of rotations of the spool 35 and the rotational speed of the spool 35. Data indicating the number of rotations of the spool 35 and the rotational speed of the spool 35 are stored in the second memory 43a and recognized by the second controller 43b.

### Fishing line information learning system

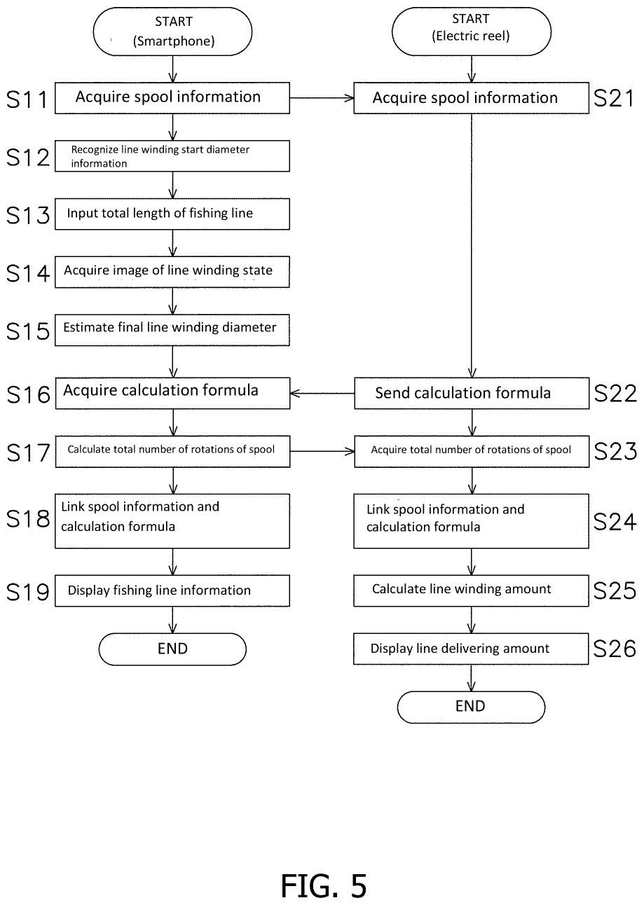

A mode for setting the fishing line information used in the learning mode in the fishing line information learning system 1 having the configuration described above will be described with reference to the flowchart of FIG. 5. In this learning mode, the total length of the fishing line to be wound is known in advance.

First, at the first time point when the winding of the fishing line is started, the smartphone 3 acquires the spool information of the electric reel 5 (S11). In the present embodiment, the identification information display portion 36 is photographed by the camera 11 of the smartphone 3 to acquire the spool information. For example, the identification information display portion 36 is photographed by the camera 11 of the smartphone 3 to acquire the outer diameter R1 of the bobbin trunk 35b as spool information. Specifically, the spool information is read from a two-dimensional barcode indicating various numerical information including the outer diameter R1. Alternatively, the two-dimensional barcode indicates a link to spool information saved on the server 100, and the various numerical information can be read from the server 100. The spool information can be acquired by input from the first input unit 15 of the smartphone 3.

As shown in FIG. 4A, when a backing line His wound around the bobbin trunk 35b at the first time point, the spool 35 is photographed by the camera 11 of the smartphone 3 to acquire, as line winding diameter information, an initial line winding diameter R2 at the first time point. Specifically, the image data captured by the camera 11 are analyzed by the first controller 21b to estimate and acquire the initial line winding diameter R2. When the angler can measure or ascertain the initial line winding diameter R2, the initial line winding diameter R2 can be acquired by input from the first input unit 15 of the smartphone 3. The spool information is stored in the first memory 21a. The line winding diameter information is sent from the first communication unit 17 of the smartphone 3 to the second communication unit 41 of the electric reel 5, and is also stored in the second memory 43a (S21).

Next, the first controller 21b of the smartphone 3 recognizes the line winding start diameter information of the spool 35 (S12). For example, the first controller 21b acquires, from the first memory 21a, the outer diameter R1 of the bobbin trunk 35b included in the spool information or the initial line winding diameter R2 (refer to FIG. 4A) when the backing line H has been wound, and recognizes the acquired diameter as initial line winding diameter information (Dm).

Subsequently, the fishing line is wound around the bobbin trunk 35b of the spool 35, and after the second time point at which the winding of the fishing line ends, the line winding amount from the first time point to the second time point, i.e., the total length of the fishing line that has been wound, is input from the first input unit 15 of the smartphone 3 and stored in the first memory 21a (S13). The total length of the fishing line is sent from the first communication unit 17 of the smartphone 3 to the second communication unit 41 of the electric reel 5, and is also stored in the second memory 43a (S23). The total length of the fishing line can be obtained from the package or label of the fishing line to be wound, or from the server 100 as fishing line information by photographing or reading (scanning, etc.) a barcode on the package or label, and be input and stored in the first memory 21a.

Next, after the second time point at which the winding of the fishing line ends, the spool 35 is photographed by the camera 11 of the smartphone 3. As a result, a line winding state image at the second time point is obtained by the smartphone 3 (S14).

The first controller 21b of the smartphone 3 estimates the final line winding diameter at the second time point on the basis of the line winding state image at the second time point (S15). For example, the first controller 21b estimates the final line winding diameter at the second time point on the basis of the line winding state image at the second time point and the flange diameter of the spool 35 in the spool information.

Specifically, the first controller 21b executes a process of averaging the outer circumferential surface of the fishing line wound around the bobbin trunk 35b of the spool 35 on the basis of the line winding state image at the second time point. The first controller 21b calculates the ratio of the diameter of the outermost surface of the fishing line with respect to the flange diameter of the spool 35, and calculates the final line winding diameter at the second time point.

Next, the first controller 21b of the smartphone 3 obtains the calculation formula for the number of rotations (d) of the spool 35 (S16). For example, the first controller 21b of the smartphone 3 requests, to the electric reel 5, the calculation formula for the number of rotations (d) of the spool 35, and the electric reel 5 sends, to the smartphone 3, the calculation formula for the number of rotations (d) of the spool 35 (S22). The calculation formula for the number of rotations (d) of the spool 35 is a formula for calculating the number of rotations (d) of the spool 35 in the range from the first time point to the second time point. The calculation formula can be acquired from the server 100 and stored in the first memory 21a of the smartphone 3. Alternatively, the calculation formula can be acquired as spool information of the identification information display portion 36.

Next, the first controller 21b of the smartphone 3 calculates a total number of rotations (dt) of the spool 35 required for winding the entire length of the fishing line around the spool 35 on the basis of the total length of the fishing line (LT), the initial line winding diameter information (Dm), and the final line winding diameter (DL) at the second time point (S17). The actual line winding amount (LT) is the amount of line that is actually wound around the spool 35 in the range from the first time point to the second time point. The total length of the fishing line (LT) is a known value. In the present embodiment, the calculation formula is expressed as “d=2LT/(DL+Dm).”

The total number of rotations (dt) of the spool 35 is stored in the first memory 21a. The total number of rotations (dt) of the spool 35 is sent from the first communication unit 17 of the smartphone 3 to the second communication unit 41 of the electric reel 5, and is also stored in the second memory 43a (S23).

Next, the second controller 43b of the electric reel 5 generates first table data indicating the correspondence between the spool information and the calculation formula, and stores the first table data in the second memory 43a (S24). The first table data are sent from the second communication unit 41 of the electric reel 5 to the first communication unit 17 of the smartphone 3, and is also stored in the first memory 21a (S18). The first table data are used when replacing spools, and the like.

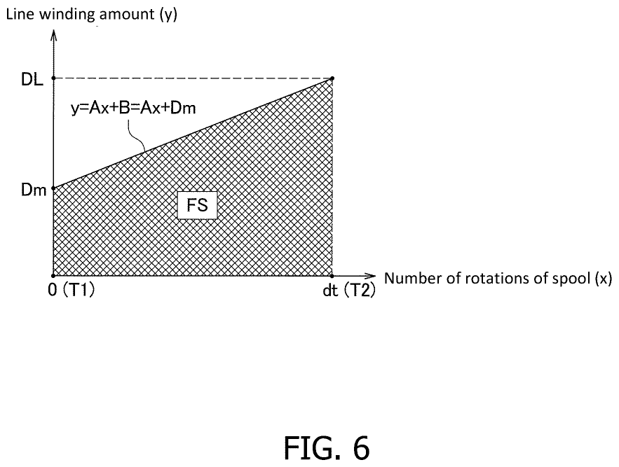

When calculating the line winding amount, the linear function shown in FIG. 6 is used. In FIG. 6, the horizontal axis is the number of rotations (x) of the spool and the vertical axis is the line winding diameter (y). The linear function is expressed, using slope (A) and intercept (B), as “y=Ax+B.”

The intercept in FIG. 6 is the initial line winding diameter information (Dm). The line winding diameter (y) corresponding to the total number of rotations (dt) of the spool 35 is the final line winding diameter (DL) at the second time point. The slope (A) indicates the rate of increase of the outer diameter. The slope (A) is calculated as “A=(y−Dm)/x=(DL−Dm)/dt=(DL2−Dm2)/2LT.” The slope (A) is stored in the second memory 43a. The learning ends therewith.

The second controller 43b detects the number of rotations of the spool 35 and calculates the line winding amount (FS) (S25). Specifically, the second controller 43b calculates “FS=∫(y=Ax+Dm); x=0 to d” to calculate the line winding amount (FS). In the present embodiment, the line winding amount (FS) is calculated as “FS=d(Ad+2Dm)/2.” The second controller 43b displays, on the second display unit 37, a numerical value obtained by subtracting the line winding amount FS from the total length LT of the fishing line, as the line delivering amount L (S26).

Here, when the first input unit 15 of the smartphone 3 is operated in order to display fishing line information used in the learning mode, the first controller 21b displays, on the first display unit 13, the fishing line information used in the learning mode (S19).

In the fishing line information learning system 1 having the configuration described above, the angler can acquire the line winding diameter information at the second time point (T2) to easily calculate the line winding amount (FS), without having to carry out cumbersome operations or tasks. Specifically, in the fishing line information learning system 1, by preparing the final line winding diameter (DL) at the second time point (T2), the initial line winding diameter information (Dm), the actual line winding amount (LT), and the calculation formula (d), the fishing line information used in the learning mode can be easily set.

### Second Embodiment

In the fishing line information learning system 1 according to the second embodiment, descriptions of configurations that are essentially the same as the first embodiment are omitted. The descriptions omitted here shall be pursuant to the descriptions of the first embodiment. In this embodiment, the total length of the fishing line is unknown and the material, thickness, etc., of the fishing line are known.

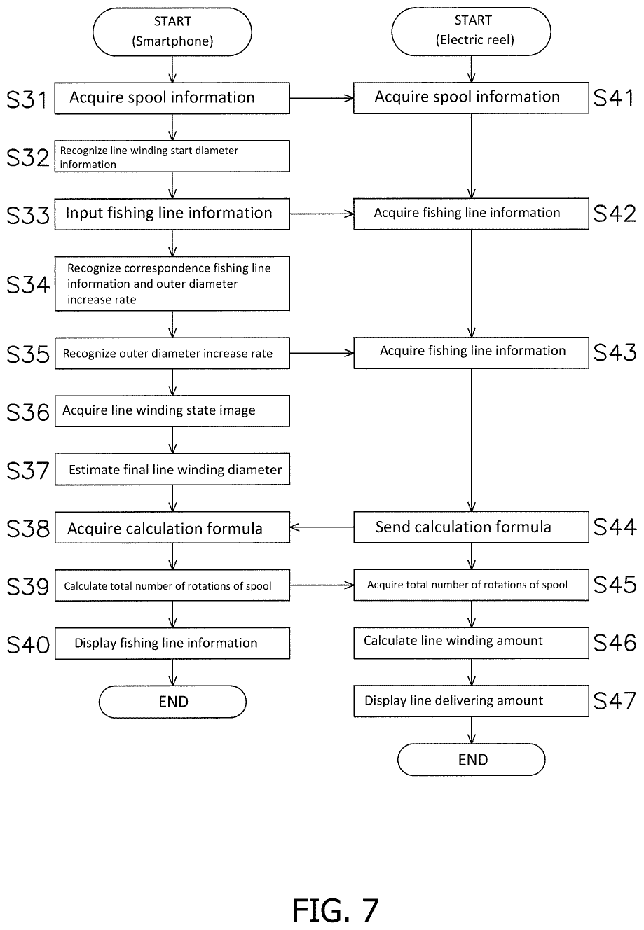

In the second embodiment, first, a process (S31) corresponding to step 11 (S11) of the first embodiment and a process (S32) corresponding to step 12 (S12) of the first embodiment are executed in the smartphone 3, as shown in FIG. 7. In the electric reel 5, a process (S41) corresponding to step 21 (S21) of the first embodiment is executed.

Next, the fishing line information is input from the first input unit 15 of the smartphone 3 and stored in the first memory 21a of the smartphone 3 (S33). The fishing line information can be obtained from the package or label of the fishing line that is to be wound, or from the server 100 by photographing a barcode on the package or label with the camera 11, in the same manner as in the first embodiment. The fishing line information is sent from the first communication unit 17 of the smartphone 3 to the second communication unit 41 of the electric reel 5 and stored in the second memory 43a (S42). The fishing line information can be input from the second input unit 39 of the electric reel 5 and stored in the second memory 43a.

Next, the first controller 21b of the smartphone 3 reads, from the first memory 21a, third table data indicating the correspondence between the fishing line information and the rate of increase (slope A of the linear function) of the outer diameter, empirically obtained from the fishing line information (S34). The first controller 21b recognizes, on the basis of the third table, the rate of increase (slope A of the linear function) of the outer diameter corresponding to the fishing line information (S35). The rate of increase (slope A of the linear function) of the outer diameter corresponding to the fishing line information is sent from the first communication unit 17 of the smartphone 3 to the second communication unit 41 of the electric reel 5 and stored in the second memory 43a (S43). The third table data can be input from the server 100 as fishing line information.

Next, a process (S36) corresponding to step 14 (S14) of the first embodiment and a process (S37) corresponding to step 15 (S15) of the first embodiment are executed in the smartphone 3.

Next, the second controller 43b of the electric reel 5 obtains the calculation formula for the total number of rotations (dt) of the spool 35 from the second memory 43a, and transmits the calculation formula to the smartphone 3 (S44). The first memory 21a of the smartphone 3 stores the calculation formula for the total number of rotations (dt) of the spool 35 (S38). The calculation formula can be acquired from the server 100 and stored in the first memory 21a of the smartphone 3. Alternatively, the calculation formula can be acquired as spool information of the identification information display portion 36. The first controller 21b of the smartphone 3 calculates the total number of rotations (dt) of the spool 35 on the basis of the initial line winding diameter information (Dm), the final line winding diameter (DL) at the second time point (T2), and the rate of increase (slope A of the linear function) of the outer diameter (S39).

In the present embodiment, the calculation formula for the total number of rotations (dt) of the spool 35 is expressed as “dt=(DL−DM)/A.” The number of rotations (d) of the spool 35 is stored in the first memory 21a. The number of rotations (d) of the spool 35 is sent from the first communication unit 17 of the smartphone 3 to the second communication unit 41 of the electric reel 5 and stored in the second memory 43a (S45).

When the first input unit 15 of the smartphone 3 is operated in order to display the fishing line information used in the learning mode after executing a process corresponding to step 18 (S18) of the first embodiment, the first controller 21b of the smartphone 3 displays the fishing line information used in the learning mode on the first display unit 13 (S40).

In the present embodiment, the total length LT of the fishing line is calculated as “LT=dt(A·dt+2Dm)/2.” The point of calculating the line winding amount FS in step 46 (S46) on the basis of the calculation formula “FS=d(A·d+2DM)/2” and displaying the line delivering amount L on the second display unit 37 in step 47 (S47) is the same as in the first embodiment.

In this manner, when the rate of increase (slope A of the linear function) of the outer diameter is determined on the basis of the fishing line information, the second controller 43b can easily calculate the number of rotations (d) of the spool 35 and the line winding amount (FS), as described above. That is, the angler can acquire the line winding state image at the second time point (T2) to easily set the fishing line information used in the learning mode, without having to carry out cumbersome operations or tasks.

### Third Embodiment

In the fishing line information learning system 1 according to the third embodiment, descriptions of configurations that are essentially the same as the first embodiment are omitted. The descriptions omitted here shall be pursuant to the descriptions of the first embodiment. In this embodiment, the total length as well as the material, thickness, etc., of the fishing line are unknown.

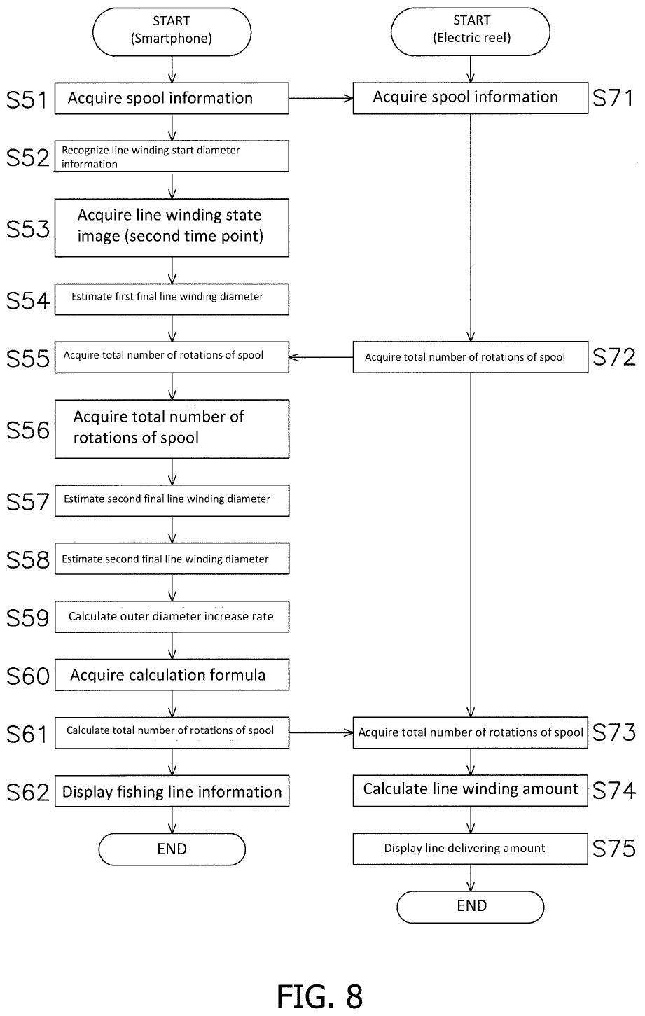

In the third embodiment, the following process is executed in a state in which the electric reel 5 is set to the learning mode. The learning mode is a mode for learning the relationship between the length of the fishing line wound around the spool and the rotation of the spool. As shown in FIG. 8, in the third embodiment, first, a process (S51) corresponding to step 11 (S11) of the first embodiment and a process (S52) corresponding to step 12 (S12) of the first embodiment are executed in the smartphone 3. In the electric reel 5, a process (S71) corresponding to step 21 (S21) of the first embodiment is executed.

Subsequently, a process (S53) corresponding to step 14 (S14) of the first embodiment and a process (S54) corresponding to step 15 (S15) of the first embodiment are executed in the smartphone 3. In step 54 (S54), the second controller 43b of the electric reel 5 recognizes the final line winding diameter at the second time point as a first final line winding diameter (DL1).

Next, a prescribed length of the fishing line is pulled out (cast) in a state in which the fishing line is wound around the bobbin trunk 35b of the spool 35. In the present embodiment, the point in time at which the prescribed length of the fishing line has been pulled out is referred to as the third time point.

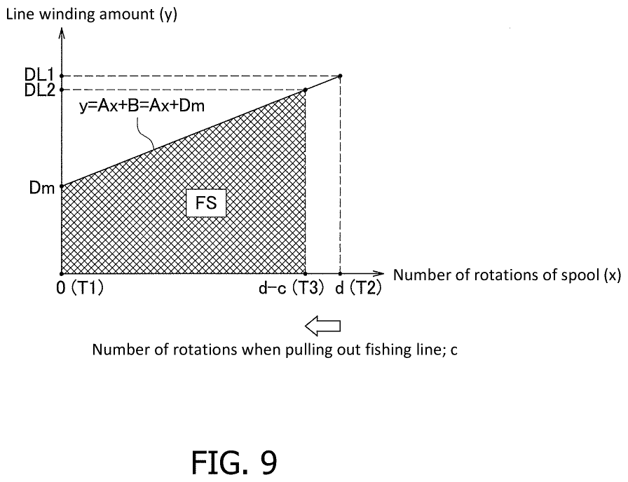

Here, the measuring unit 45 of the electric reel 5 measures the number of rotations of the spool 35 between the second time point and the third time point (S72). The number of rotations of the spool 35 is stored in the second memory 43a. The second controller 43b of the electric reel 5 recognizes, as a measured number of rotations, the number of rotations of the spool 35 measured by the measuring unit 45 between the second time point and a third time point. In the following description, the measured number of rotations from the second time point to the third time point is indicated by the symbol “c,” as shown in FIG. 9. The measured number of rotations c from the second time point to the third time point is stored in the first memory 21a from the second communication unit 41 of the electric reel via the first communication unit 17 of the smartphone 3 (S55).

Subsequently, after the fishing line has been pulled out at the third time point, the spool 35 and the fishing line wound around the bobbin trunk 35b are photographed by the camera 11 of the smartphone 3. As a result, the line winding state image at the third time point is acquired (S56). The line winding state image at the third time point is image data including the spool 35 and the fishing line wound around the bobbin trunk 35b of the spool 35 at the third time point.

Subsequently, the first controller 21b of the smartphone 3 estimates the second final line winding diameter at the third time point on the basis of the line winding state image at the third time point (S57). For example, the first controller 21b estimates the second final line winding diameter at the third time point on the basis of the line winding state image at the third time point and the flange diameter of the spool 35.

Specifically, the first controller 21b executes a process of averaging the outer circumferential surface of the fishing line wound around the bobbin trunk 35b of the spool 35 on the basis of the line winding state image at the third time point. The first controller 21b calculates the ratio of the diameter of the outermost surface of the fishing line with respect to the outer circumferential surface of the flange portion 35a of the spool 35, calculates the second final line winding diameter (DL2) at the third time point, and recognizes the second final line winding diameter (DL2) at the third time point (S58).

Subsequently, the first controller 21b of the smartphone 3 acquires the calculation formula for the rate of increase (slope A of the linear function) of the outer diameter from the first memory 21a and calculates the rate of increase (slope A of the linear function) of the outer diameter (S59). In the present embodiment, as shown in FIG. 9, the calculation formula for the rate of increase (slope A of the linear function) of the outer diameter is expressed as “A=(DL1−DL2)/c.” The rate of increase (slope A of the linear function) of the outer diameter is stored in the first memory 21a.

Subsequently, the first controller 21b acquires, from the first memory 21a, the calculation formula for the number of rotations (d) of the spool 35 at the second time point (S60) and calculates the number of rotations (d) of the spool 35 at the second time point (S61). In the present embodiment, the calculation formula for the number of rotations (d) of the spool 35 at the second time point is expressed as “d=DL1−Dm/A=c(DL−Dm)/(DL1−DL2).” The number of rotations (d) of the spool 35 at the second time point is stored in the first memory 21a.

Subsequently, the electric reel 5 acquires the number of rotations (d) of the spool 35 at the second time point from the smartphone 3 (S73), and the second controller 43b calculates the line winding amount (FS) on the basis of the first final line winding diameter (DL1), the initial line winding diameter information (Dm), the measured number of rotations (c), and the second final line winding diameter (DL2) (S74). In the present embodiment, the calculation formula for the line winding amount (FS) is expressed as “FS=c(DL1\hat{ }2−Dm\hat{ }2)/{2(DL1−DL2)}.” The line winding amount (FS) is stored in the second memory 43a. The second controller 43b displays the line delivering amount L on the second display unit 37, in the same manner as in step 26 (S26) of the first embodiment (S75).

Here, when the first input unit 15 of the smartphone 3 is operated in order to display fishing line information used in the learning mode, the first controller 21b displays, on the first display unit 13, the fishing line information used in the learning mode (S62).

In this manner, by pulling out the fishing line between the second time point (T2) to the third time point (T3), the second controller 43b can easily calculate the number of rotations (d) of the spool 35 at the second time point (T2), the rate of increase (slope A of the linear function) of the outer diameter, and the line winding amount (FS), as described above. That is, the angler can acquire the line winding state image at the second time point (T2) and the line winding state image at the third time point (T3) to easily set the fishing line information used in the learning mode, without having to carry out cumbersome operations or tasks.

### Other Embodiments

One embodiment of the present disclosure is described above, but the present disclosure is not limited to the above-described first to the third embodiments, and various modifications can be made without departing from the scope of the disclosure. Especially, the multiple embodiments and modified examples described in the present Specification can be combined in any manner according to necessity.

In the first to the third embodiments, examples were shown in which the line winding amount is calculated in the smartphone 3. The line winding amount can be calculated in the electric reel 5. In this case, the information necessary for calculating the line winding amount is stored in the second memory 43a of the electric reel 5. In addition, the fishing line information used in the learning mode is sent from the second communication unit 41 of the electric reel 5 to the first communication unit 17 of the smartphone 3 and stored in the first memory 21a.

In the first to the third embodiments, examples were shown in which the identification information display portion 36 is photographed by the camera 11 of the smartphone 3 to automatically acquire the spool information. The spool information can be manually input from the first input unit 15 of the smartphone 3 and/or the second input unit 39 of the electric reel 5.

In addition, the identification information display portion 36 can include individual identification information of the spool 35. Given such a configuration, learning results can be linked with the individual identification information and stored in the smartphone 3 or the electric reel 5, so that, even if the spool 35 is replaced, information can be read from the identification information display portion 36 to call up the learning results corresponding to the spool 35 and the fishing line wound around the spool 35. These pieces of information can also be saved on the server 100 via the Internet.

What is claimed is:

1. A fishing line information learning system, comprising:
a fishing reel having a first communication unit and a spool including a pair of flange portions and a bobbin trunk, the bobbin trunk configured to have fishing line wound therearound between the pair of flange portions; and
an electronic device having a camera configured to be capable of photographing the spool, a second communication unit configured to communicate with the first communication unit, and a first memory configured to store first information acquired by the camera,
the fishing reel or the electronic device having
a second memory configured to store a calculation formula to calculate a line winding amount of the fishing line in a range from a first time point when the winding of the fishing line is started to a second time point when the winding of the fishing line is ended, and
a controller configured to estimate a final line winding diameter at the second time point based on the first information at the second time point, and calculate the line winding amount based on the final line winding diameter and the calculation formula.

2. The fishing line information learning system according to claim 1, wherein
the first memory or the second memory is configured to store an outer diameter of the bobbin trunk or initial line winding diameter information corresponding to an initial line winding diameter at the first time point, and
the controller is configured to calculate the line winding amount based on the final line winding diameter, the initial line winding diameter information, an actual line winding amount in the range, and the calculation formula.

3. The fishing line information learning system according to claim 1, wherein
the first memory or the second memory is configured to store
an outer diameter of the bobbin trunk or initial line winding diameter information corresponding to an initial line winding diameter at the first time point, and
second information pertaining to the fishing line, and
the controller is configured to calculate the line winding amount based on the final line winding diameter, the initial line winding diameter information, the second information, and the calculation formula.

4. The fishing line information learning system according to claim 1, wherein
the fishing reel has a measuring unit configured to measure a number of rotations of the spool,
the first memory or the second memory is configured to store an outer diameter of the bobbin trunk or initial line winding diameter information corresponding to an initial line winding diameter at the first time point, and
the controller is configured to recognize the final line winding diameter at the second time point as a first final line winding diameter,
recognize, as a measured number of rotations, a number of rotations of the spool measured by the measuring unit between the second time point and a third time point at which a prescribed length of the fishing line has been pulled out,
estimate a second final line winding diameter at the third time point based on the first information at the third time point, and
calculate the line winding amount based on the first final line winding diameter, the initial line winding diameter information, the measured number of rotations, the second final line winding diameter, and the calculation formula.

5. The fishing line information learning system according to claim 1, wherein
the flange portion or the bobbin trunk includes an identification information display portion including third information relating to the spool,
the identification information display portion includes at least one of a one-dimensional barcode, a two-dimensional barcode, or character information, and
when the identification information display portion is photographed by the camera, the controller stores the third information in the first memory or the second memory.

6. The fishing line information learning system according to claim 5, wherein
the electronic device has a display unit to display information in the first memory, and
the display unit is configured to display the third information.

7. The fishing line information learning system according to claim 5, wherein
the controller is configured to generate table data indicating a relationship between the third information and the calculation formula, and
store the table data in the first memory or the second memory.

8. The fishing line information learning system according to claim 5, wherein
the flange portion or the bobbin trunk has a recess, and
the identification information display portion is disposed in the recess.
